(19) United States
(12) Patent Application Publication
(10) Pub. No.: US 2024/0335843 A1
(43) Pub. Date: Oct. 10, 2024

(54) GAS-LIQUID SEPARATOR

(71) Applicant: MAYEKAWA MFG. CO., LTD., Koto-ku, Tokyo (JP)

(72) Inventors: Yasushi TOMIYAMA, Koto-ku, Tokyo (JP); Ryuuji HAYASHI, Koto-ku, Tokyo (JP); Ichiro SEKINE, Koto-ku, Tokyo (JP); Takashige INABA, Koto-ku, Tokyo (JP); Tsuyoshi ITAGAKI, Koto-ku, Tokyo (JP)

(73) Assignee: MAYEKAWA MFG. CO., LTD., Koto-ku, Tokyo (JP)

(21) Appl. No.: 17/801,335

(22) PCT Filed: Dec. 21, 2020
(86) PCT No.: PCT/JP2020/047667

§ 371 Date: Jun. 4, 2024

(30) Foreign Application Priority Data
Feb. 25, 2020 (WO) PCT/JP2020/007487
Sep. 11, 2020 (WO) PCT/JP2020/034459

(51) Int. Cl. B04C 5/103; B01D 45/08; B01D 45/16; B04C 5/04; F25B 43/02

(52) U.S. Cl. CPC B04C 5/103; B01D 45/08; B01D 45/16; B04C 5/04; F25B 43/02

(57) ABSTRACT

A gas-liquid separator that can suitably separate gas and liquid by increasing a flow velocity of a gas-liquid mixture that flows into a body portion includes a body portion having a cylindrical shape, an introduction passage provided in a state of communicating with the body portion, a gas-liquid mixture being introduced through the introduction passage, and a straightening plate attached to the body portion, the straightening plate straightening the gas-liquid mixture, wherein the straightening plate has a narrow width portion configured such that a distance between the straightening plate and an inner wall of the body portion gradually decreases toward an end portion from which the gas-liquid mixture flows out.

### TECHNICAL FIELD

The present invention relates to a gas-liquid separator that separates gas and liquid from a gas-liquid mixture.

### BACKGROUND ART

In a gas compressor that compresses gas, such as air, a refrigerant gas, or a process gas, for the purpose of cooling, lubrication or the like, lubricating oil (liquid), such as refrigerating machine oil, is used for gas, such as air or gas suctioned into the compressor. Accordingly, lubricating oil is present in a mixed state in the gas ejected from the compressor.

Therefore, it is necessary for the gas ejected from the compressor to be temporarily introduced into a gas-liquid separator so as to separate refrigerating machine oil in the gas-liquid separator.

As such a gas-liquid separator, for example, Patent Literature 1 described below discloses a gas-liquid separator that centrifuges gas and liquid by blowing a gas-liquid mixture into a body portion having a cylindrical shape.

In the gas-liquid separator disclosed in Patent Literature 1, a guide plate having a curved shape is attached to a gas-liquid separator body (body portion), being a pressure vessel having a cylindrical shape, with a predetermined distance between an inner wall of the body portion and the guide plate to form a guide path between the inner wall of the body portion and the guide plate, thus causing a gas-liquid mixture to swirl in a long-distance receiver tank.

### Citation List

### Patent Literature

Patent Literature 1: JP 2004-52710 A

### SUMMARY OF INVENTION

### Technical Problem

However, in the gas-liquid separator disclosed in the above-mentioned Patent Literature 1, the guide plate is formed to have a shape where the distance between the guide plate and the inner wall of the body portion gradually increases within a range of a predetermined length from one end toward the other end side of the guide plate and hence, a flow velocity of a gas-liquid mixture that flows into the body portion decreases in the guide path. When the flow velocity of the gas-liquid mixture decreases, there may be a case where the gas-liquid mixture does not sufficiently swirl in the body portion, so that there is a possibility that gas and liquid cannot be suitably separated. Further, an introduction passage is attached to the body portion in a state of being parallel to a tangent with respect to an outer wall of the body portion and of being disposed at a position close to the tangent. Accordingly, it is difficult to attach the introduction passage in manufacture, and the number of work steps increases.

The present invention has been made to solve the above-mentioned problems, and it is an object of the present invention to provide a small-sized or compact gas-liquid separator that can suitably separate gas and liquid by increasing the flow velocity of the gas-liquid mixture that flows into the body portion.

### Solution to Problem

A gas-liquid separator according to the present invention that achieves the above-mentioned object is a gas-liquid separator that separates gas and liquid from a gas-liquid mixture. The gas-liquid separator includes: a body portion having a cylindrical shape; an introduction passage provided in a state of communicating with the body portion, the gas-liquid mixture being introduced through the introduction passage; a straightening plate attached to the body portion to extend in a chord length direction of a circular arc formed at a barrel of the body portion, the straightening plate being configured to straighten the gas-liquid mixture; and an exhaust flow passage provided for gas from which liquid is separated. The straightening plate has a narrow width portion configured such that a distance between the straightening plate and an inner wall of the body portion gradually decreases toward an end portion from which the gas-liquid mixture flows out. A swirl portion in the body portion is formed by the body portion extending in an up-and-down direction and a partition plate.

### Advantageous Effects of Invention

In the above-mentioned gas-liquid separator, the straightening plate has the narrow width portion configured such that the distance between the straightening plate and the inner wall of the body portion gradually decreases toward the end portion from which the gas-liquid mixture flows out. Accordingly, it is possible to increase a flow velocity of the gas-liquid mixture and it is possible to effectively make use of a space in the barrel and hence, gas and liquid can be suitably separated.

### BRIEF DESCRIPTION OF DRAWINGS

FIG. 1 is a schematic transparent view showing a gas-liquid separator according to an embodiment of the present invention.

FIG. 2 is a schematic vertical cross-sectional view showing the gas-liquid separator according to this embodiment.

FIG. 3 is a diagram taken along a line A-A and seen from a direction indicated by arrows in FIG. 2, the diagram showing the gas-liquid separator according to this embodiment.

FIG. 4 is a diagram for describing a configuration of a straightening plate of the gas-liquid separator according to this embodiment.

FIG. 5 is a diagram showing a gas-liquid separator according to a modification 1, the diagram corresponding to FIG. 3.

FIG. 6 is a diagram showing the gas-liquid separator according to the modification 1, the diagram corresponding to FIG. 4.

FIG. 7 is a diagram showing a gas-liquid separator according to a modification 2, the diagram corresponding to FIG. 2.

FIG. 8 is a diagram showing a gas-liquid separator according to a modification 3, the diagram corresponding to FIG. 2.

FIG. 9 is a schematic bottom view showing the gas-liquid separator according to the modification 3.

FIG. 10 is a diagram showing a gas-liquid separator according to a modification 4, the diagram corresponding to FIG. 2.

FIG. 11 is a graph showing a relationship between a flow velocity of a gas-liquid mixture and a separation efficiency.

### DESCRIPTION OF EMBODIMENTS

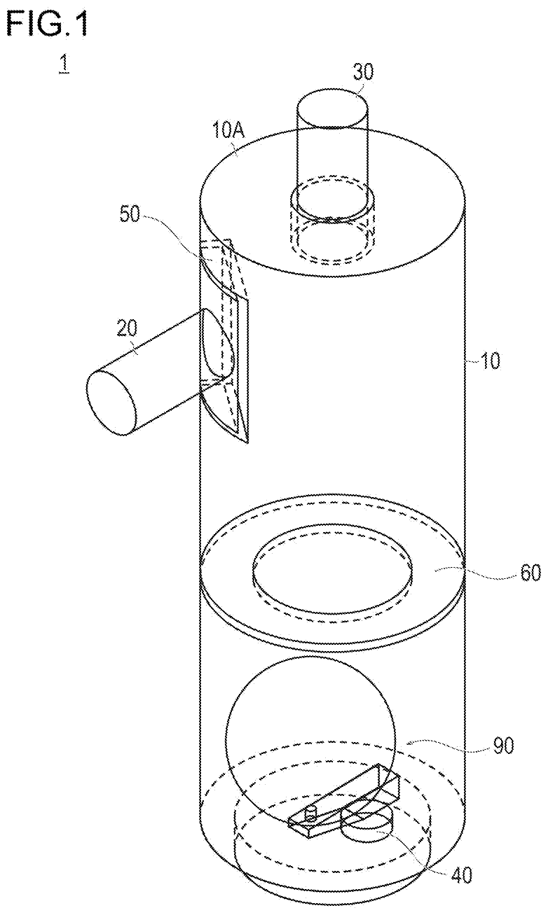

An embodiment of the present invention will be described with reference to FIG. 1 to FIG. 4. In the description of the drawings, identical elements are given the same reference symbols, and the repeated description will be omitted. The dimensional ratios in the drawings are exaggerated for convenience of description, and may be different from the actual ratios.

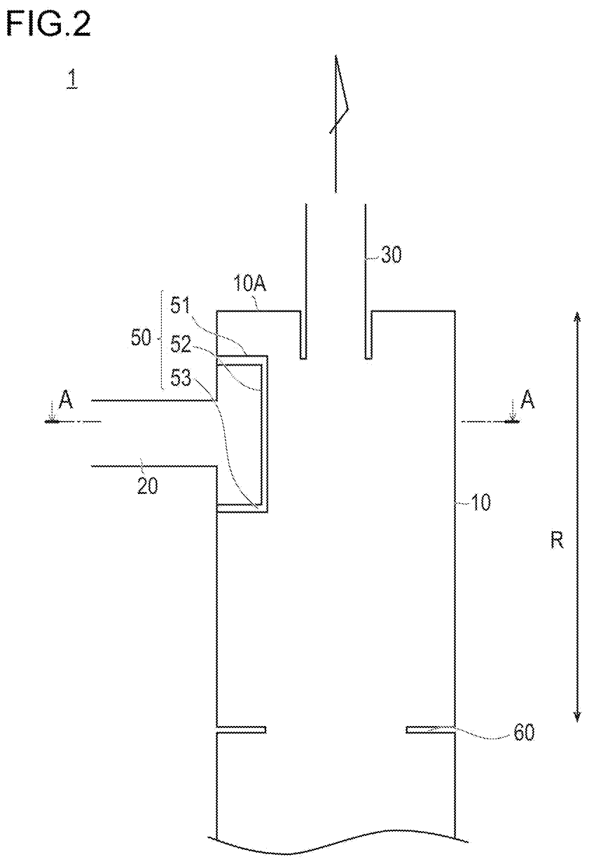

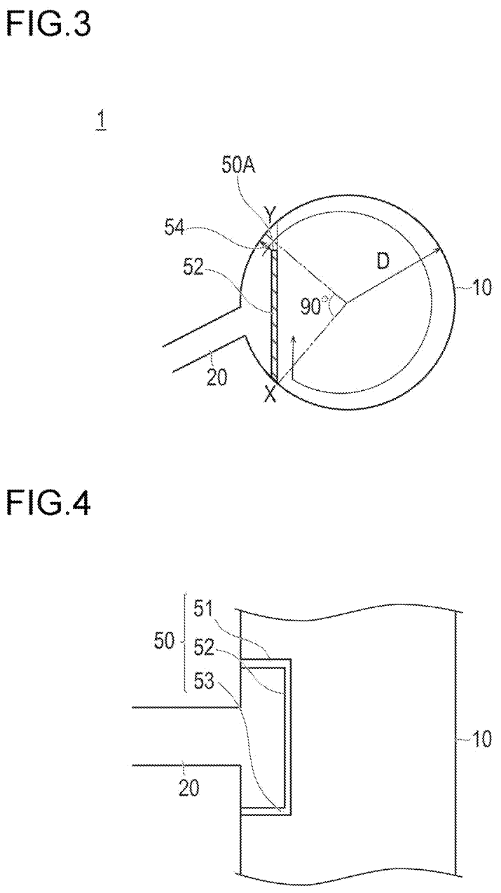

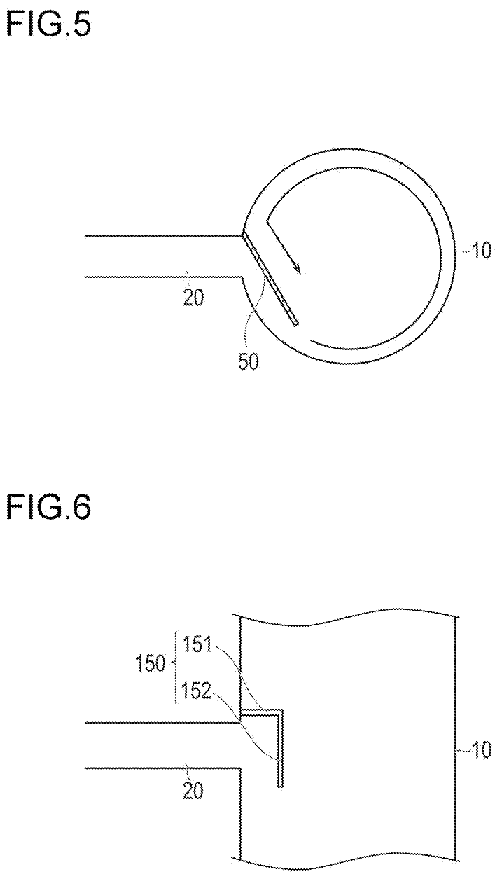

FIG. 1 is a schematic transparent view showing a gas-liquid separator 1 according to an embodiment of the present invention. FIG. 2 is a schematic vertical cross-sectional view showing the gas-liquid separator 1 according to this embodiment. FIG. 3 is a diagram taken along a line A-A and seen from a direction indicated by arrows in FIG. 2, the diagram showing the gas-liquid separator 1 according to this embodiment. FIG. 4 is a diagram for describing a configuration of a straightening plate 50 of the gas-liquid separator 1 according to this embodiment.

As shown in FIG. 1, the gas-liquid separator 1 includes a body portion 10, an introduction passage 20, an exhaust flow passage 30, an oil discharge flow passage 40, the straightening plate 50, and a partition plate 60, the body portion 10 having a cylindrical shape, a gas-liquid mixture being introduced through the introduction passage 20, gas being exhausted through the exhaust flow passage 30, a refrigerating machine oil being discharged through the oil discharge flow passage 40, the straightening plate 50 straightening the gas-liquid mixture, and the partition plate 60 being provided at a position lower than the introduction passage 20. The gas-liquid separator 1 is used for a gas compressor, is preferably used for a high-speed multicylinder refrigerating machine, and is more preferably used for a high-speed multicylinder refrigerating machine for ship. The gas-liquid separator 1 is used for returning oil accompanied by a compressed gas to a crankcase.

The body portion 10 is formed into a cylindrical shape extending in an up-and-down direction. In this configuration, unlike a configuration disclosed in JP 5-296610 A in which a conical funnel is provided at a lower portion or a configuration in which a swirl flow is generated by using a gas outflow pipe as an inner cylinder, there is no inner cylinder forming a resistance against a swirl flow is not provided and hence, the swirl flow is efficiently formed only by the cylindrical shape. Accordingly, by providing the partition plate 60, it is possible to narrow a swirl region R (see FIG. 2). Therefore, by increasing a swirl speed without dispersing the swirl flow, it is possible to improve a separation efficiency. Further, there is no conical funnel portion and hence, it is possible to form the gas-liquid separator 1 in a compact manner.

Although the body portion 10 is formed of a steel pipe, for example, the body portion 10 is not limited to the steel pipe. Although the size of the body portion 10 is not particularly limited, it is preferable to set the size of the body portion 10 to a size that allows gas and liquid to be suitably separated. Specifically, it is preferable to set the size of the body portion 10 to a volume that allows a gas-liquid mixture to have a retention time of 0.6 seconds or more.

As shown in FIG. 3, the straightening plate 50 is disposed to extend in a chord length direction of a circular arc formed at a barrel of the body portion 10 when viewed from above. One end of the straightening plate 50 is connected to an inner wall of the body portion 10, and the other end of the straightening plate 50 has an end portion 50A. The straightening plate 50 has a narrow width portion configured such that a distance between the straightening plate 50 and the inner wall of the body portion 10 gradually decreases.

As shown in FIG. 1 and FIG. 2, the introduction passage 20 is provided in a state of communicating with the body portion 10. The introduction passage 20 is provided as shown in FIG. 3. As shown in FIG. 3, the introduction passage 20 is provided at a free angle with respect to a center of the body portion 10 within a range of a circular arc formed with a length corresponding to 1/4 or less (90° or less shown in FIG. 3) of a circumference of the barrel of the body portion 10.

In a case where the introduction passage 20 is attached to extend in a tangential direction with respect to the body portion 10, for example, it is difficult to form a distorted hole in the body portion 10 and to weld the introduction passage 20 to the body portion 10. In contrast, in the gas-liquid separator 1 according to this embodiment, the introduction passage 20 is provided at the free angle and with a free offset amount with respect to the center of the body portion 10 and hence, it is possible to easily weld the introduction passage 20 to the body portion 10.

As shown in FIG. 1, the exhaust flow passage 30 is provided at an upper portion of the body portion 10. Gas (gas) separated from a refrigerating machine oil (liquid) is exhausted through the exhaust flow passage 30.

As shown in FIG. 2, an insertion portion of the exhaust flow passage 30 is configured to extend downward a short distance from an upper end portion 10A of the body portion 10.

For example, assume a case where the exhaust flow passage 30 has no insertion portion and is configured to extend upward from the upper end portion 10A, and the introduction passage 20 and the exhaust flow passage 30 are disposed close to each other. In such a case, there is a possibility that, of a gas-liquid mixture that flows out in an upward direction from the end portion 50A of the straightening plate 50, a portion of gas from which refrigerating machine oil is not sufficiently separated or a portion of refrigerating machine oil separated from the gas due to impingement separation is suctioned into the exhaust flow passage 30 and is discharged to the outside.

In contrast, the gas-liquid separator 1 according to this embodiment is configured such that the insertion portion of the exhaust flow passage 30 extends downward in a short distance from the upper end portion 10A of the body portion 10. Accordingly, of a gas-liquid mixture that flows out from the end portion 50A of the straightening plate 50, an unseparated gas that is discharged to an outer peripheral region of the insertion portion in a space above the straightening plate 50 or refrigerating machine oil separated from the gas is prevented from directly flowing into the exhaust flow passage 30 and hence, it is possible to suitably suppress a situation where the unseparated gas or the refrigerating machine oil is discharged to the outside.

As shown in FIG. 2, it is preferable to stop the downward extension of the insertion portion of the exhaust flow passage 30 before the insertion portion reaches a position in the vicinity of a height of a first extending portion 51 of the straightening plate 50, which will be described later. Such a configuration can suppress a situation where the insertion portion of the exhaust flow passage 30 obstructs a generated swirl flow. Further, the insertion portion of the exhaust flow passage 30 can be easily assembled and constructed.

A lower portion of the body portion 10 forms an oil storage portion. As shown in FIG. 1, the oil discharge flow passage 40 is provided at the lower portion of the body portion 10. Refrigerating machine oil separated from gas is discharged through the oil discharge flow passage 40. A float valve 90 is disposed above the oil discharge flow passage 40. The float valve 90 has a known configuration and hence, the detailed description of the float valve 90 will be omitted.

When the float valve 90 is opened, refrigerating machine oil stored at the lower portion of the body portion 10 is discharged through the oil discharge flow passage 40. After a lapse of a predetermined time period, the float valve 90 is closed and refrigerating machine oil is stored at the lower portion of the body portion 10.

The straightening plate 50 causes a gas-liquid mixture introduced through the introduction passage 20 to be subject to impingement separation and changes a flow direction to a circumferential direction to straighten the flow. At the same time, the straightening plate 50 increases a flow velocity of the gas-liquid mixture introduced through the introduction passage 20.

As shown in FIG. 3 and FIG. 4, the straightening plate 50 is fixed to an inner wall of an inflow portion formed in the inside of the body portion 10. The straightening plate 50 includes the first extending portion 51, a second extending portion 52, and a third extending portion 53, the first extending portion 51 extending inward in the substantially horizontal direction from an inner wall of the body portion 10, the second extending portion 52 being continuously formed with the first extending portion 51 and extending in a downward direction, the third extending portion 53 being continuously formed with the second extending portion 52 and extending to the inner wall of the body portion 10.

For example, as shown in FIG. 3, the straightening plate 50 is attached to extend along an X-Y line, that is, to extend in a chord length direction of a circular arc formed with a length corresponding to 1/4 or less (90° or less shown in FIG. 3) of the circumference of the barrel of the body portion 10. As shown in FIG. 4, the straightening plate 50 is formed into a square U shape or a U shape when viewed in a front view. The straightening plate 50 may be formed as an integral body by the first extending portion 51, the second extending portion 52, and the third extending portion 53.

Although a method for fixing the first extending portion 51 and the third extending portion 53 to the inner wall of the body portion 10 is not particularly limited, the first extending portion 51 and the third extending portion 53 are fixed to the inner wall of the body portion 10 by welding, for example. The straightening plate 50 may be integrally formed with the inner wall of the body portion 10. As described above, the first extending portion 51 does not vary the shape of a narrow width portion 54 with respect to the body portion 10 and hence, it is possible to prevent breakage of the straightening plate 50 or a: reduction in service life of the straightening plate 50. As shown in FIG. 3, the straightening plate 50 extends to cover the introduction passage 20 such that a gas-liquid mixture introduced through the introduction passage 20 impinges on the straightening plate 50.

FIG. 3 shows one straightening plate 50 that has both a function of an impingement separation portion and a function of a flow direction straightening portion. The flow direction straightening portion may be formed by the straightening plate 50 where the flow passage is narrowed toward the narrow width portion 54.

The narrow width portion 54 has a narrow flow passage toward an internal opening. The narrow width portion 54 generates a swirl flow in the inside of the barrel while ensuring a gas flow velocity suitable for centrifugation. The narrow width portion 54 also has a function of causing the gas-liquid mixture to diagonally impinge on a flow swirling in the barrel so as to prevent the gas-liquid mixture from opposing the flow swirling in the barrel.

As shown in FIG. 3 and FIG. 4, the first extending portion 51 is formed to have a linear shape when viewed from above and when viewed in a front view. As shown in FIG. 4, the second extending portion 52 is also formed to have a linear shape when viewed in a front view.

As described above, the first extending portion 51 and the third extending portion 53 are fixed to the inner wall of the body portion 10 at positions above and below the introduction passage 20 and hence, the first extending portion 51 and the third extending portion 53 act as baffle plates. Accordingly, it is possible to suitably suppress a situation where, of the gas-liquid mixture introduced through the introduction passage 20, refrigerating machine oil is discharged through the exhaust flow passage 30.

As shown in FIG. 3, the first extending portion 51 and the third extending portion 53 of the straightening plate 50 have the narrow width portion 54 configured such that a distance between the straightening plate 50 and the inner wall of the body portion 10 gradually decreases toward the end portion 50A when viewed from above, the gas-liquid mixture flowing out from the end portion 50A.

That is, in the vicinity of the narrow width portion 54, the straightening plate 50 gradually approaches the inner wall of the body portion 10 toward the end portion 50A of the first extending portion 51 and the third extending portion 53. As shown in FIG. 3, the straightening plate 50 is formed to have a linear shape when viewed from above. With such a configuration, it is possible to increase a flow velocity of the gas-liquid mixture and hence, gas and liquid can be separated more suitably. Further, such a configuration does not require a guide plate and a guide path that are formed in the circumferential direction for approximately half of the circumference, the guide plate and the guide path being disclosed in JP 2004-52710 A. Accordingly, a simple configuration can be achieved.

When the flow velocity of the gas-liquid mixture in the introduction passage 20 is 4 m/s to 10 m/s, for example, the flow velocity of the gas-liquid mixture at the end portion 50A of the straightening plate 50 is 6 m/s to 15 m/s.

As shown in FIG. 1, the partition plate 60 is provided at a position lower than the introduction passage 20. The partition plate 60 is connected to the inner wall of the body portion 10. The partition plate 60 has a small inner diameter, thus having an inner diameter of a so-called toroidal shape. Although the inner diameter of the partition plate 60 is not particularly limited, the inner diameter of the partition plate 60 is 0.4 to 0.6 times the inner diameter of the body portion 10.

The partition plate 60 is formed separately from the body portion 10. The partition plate 60 is fixed to the body portion 10 by welding, for example.

The partition plate 60 is formed along an XY plane. That is, the partition plate 60 is configured to be substantially horizontal without being inclined with respect to the gas-liquid separator 1. The partition plate 60 is provided along the horizontal direction as described above and hence, it is possible to easily manufacture the gas-liquid separator 1.

By providing the partition plate 60 as described above, compared with a configuration where the partition plate is not provided, the swirl region R (see FIG. 2) extending along the up-and-down direction is narrowed and hence, it is possible to increase a swirl speed. Accordingly, it is possible to suitably separate gas and liquid.

As shown in FIG. 1, the partition plate 60 is disposed at a position sufficiently away from the exhaust flow passage 30. With such a configuration, oil adhering to the inner wall of the body portion 10 due to the swirl flow of the gas-liquid mixture is gravitationally precipitated and temporarily stays on the partition plate 60, and then descends to the oil discharge flow passage 40 from an opening portion of the partition plate 60 without flowing out through the exhaust flow passage 30, the oil discharge flow passage 40 being disposed at a position lower than the opening portion of the partition plate 60.

When a gas-liquid mixture is introduced into the gas-liquid separator 1 having the above-mentioned configuration through the introduction passage 20, the introduced gas-liquid mixture flows between the inner wall of the body portion 10 and the straightening plate 50 and flows out from the end portion 50A of the straightening plate 50. The straightening plate 50 has the narrow width portion 54 and hence, the gas-liquid mixture flows out from the end portion 50A of the straightening plate 50 at an increased flow velocity. The gas-liquid mixture that flows out from the end portion 50A of the straightening plate 50 swirls along the inner wall of the body portion 10, so that gas and liquid are centrifuged (see FIG. 3). In a region where swirling starts from the end portion 50A of the straightening plate 50, there is no obstacles inhibiting the formation of the swirl flow, such as the inner cylinder, and no surface or protrusion impinging on oil droplets at right angles and thus causing scattering of the oil droplets. Accordingly, centrifugation can be performed by effectively using the inside of the barrel and hence, a high efficiency is achieved.

In a case where oil droplets of refrigerating machine oil have a small size, the refrigerating machine oil is not easily centrifuged. Therefore, when the gas-liquid mixture swirls along the inner wall of the body portion 10, oil droplets are collected to form large oil droplets. With such a configuration, it is possible to cause the oil droplets to be gravitationally precipitated along the inner wall of the body portion 10.

As described above, the gas-liquid separator 1 according to this embodiment is the gas-liquid separator 1 that separates gas and liquid from a gas-liquid mixture. The gas-liquid separator 1 includes the body portion 10, the introduction passage 20, the straightening plate 50, and the exhaust flow passage 30, the body portion 10 having a cylindrical shape, the introduction passage 20 being provided in a state of communicating with the body portion 10, the gas-liquid mixture being introduced through the introduction passage 20, the straightening plate 50 being attached to the body portion 10 and straightening the gas-liquid mixture to increase a flow velocity, and the exhaust flow passage 30 being provided for gas from which liquid is separated. The straightening plate 50 is attached to extend in the chord length direction of the circular arc formed with the length corresponding to 1/4 or less (90° or less as shown in FIG. 3) of the circumference of the barrel of the body portion 10. The introduction passage 20 is connected at a free angle and a free offset amount within a range of the circular arc. The straightening plate 50 has the narrow width portion 54 configured such that a distance between the straightening plate 50 and the inner wall of the body portion 10 gradually decreases toward the end portion 50A from which the gas-liquid mixture flows out. In the gas-liquid separator 1 having such a configuration, the straightening plate 50 has the narrow width portion 54 configured such that the distance between the straightening plate 50 and the inner wall of the body portion 10 gradually decreases toward the end portion 50A from which the gas-liquid mixture flows out. Accordingly, it is possible to suitably separate gas and liquid by increasing the flow velocity of the gas-liquid mixture.

The straightening plate 50 is formed to have a linear shape when viewed from above. For the gas-liquid separator 1 having such a configuration, it is possible to easily manufacture the straightening plate 50.

When viewed in a front view, the straightening plate 50 is fixed to the inner wall of the body portion 10 at a position higher than the introduction passage 20. In the gas-liquid separator 1 having such a configuration, it is possible to suitably suppress a situation where, of a gas-liquid mixture that flows out from the end portion 50A of the straightening plate 50, refrigerating machine oil separated from gas is discharged through the exhaust flow passage 30.

The gas-liquid separator 1 further includes the partition plate 60 provided at a position lower than the introduction passage 20 and having the inner diameter of a toroidal shape which is smaller than the inner diameter of the body portion 10. In the gas-liquid separator 1 having such a configuration, it is unnecessary to use an auxiliary swirling mechanism, such as an inner cylinder, in the inside of the body portion 10 and it is possible to sufficiently make use of the swirl region R extending along the up-and-down direction. Accordingly, the swirl region R is narrowed and a swirl speed can be increased and hence, it is possible to separate gas and liquid more suitably.

The partition plate 60 is provided along the horizontal direction. In the gas-liquid separator 1 having such a configuration, it is possible to easily form the partition plate 60. Gas fluid from which oil is separated rises at the center of the swirl flow from the partition plate 60 toward the exhaust flow passage 30. The gas-liquid separator 1 having such a configuration does not require the tapered portion of the barrel which is provided at the lower portion of a conventional barrel, thus contributing to achieving a compact configuration.

The present invention is not limited to the above-mentioned embodiment, and various modifications are conceivable without departing from Claims.

For example, in the above-mentioned embodiment, as shown in FIG. 3 and FIG. 4, the straightening plate 50 includes the first extending portion 51, the second extending portion 52, and the third extending portion 53 and is formed into a square U shape, the first extending portion 51 extending substantially horizontally inward from the inner wall of the body portion 10, the second extending portion 52 being formed continuously with the first extending portion 51 and extending in the downward direction, the third extending portion 53 being formed continuously with the second extending portion 52 and extending to the inner wall of the body portion 10. However, as shown in FIG. 6, a straightening plate 150 may be formed into an L shape including a first extending portion 151 and a second extending portion 152, the first extending portion 151 extending substantially horizontally inward from the inner wall of the body portion, the second extending portion 152 being formed continuously with the first extending portion 151 and extending in the downward direction.

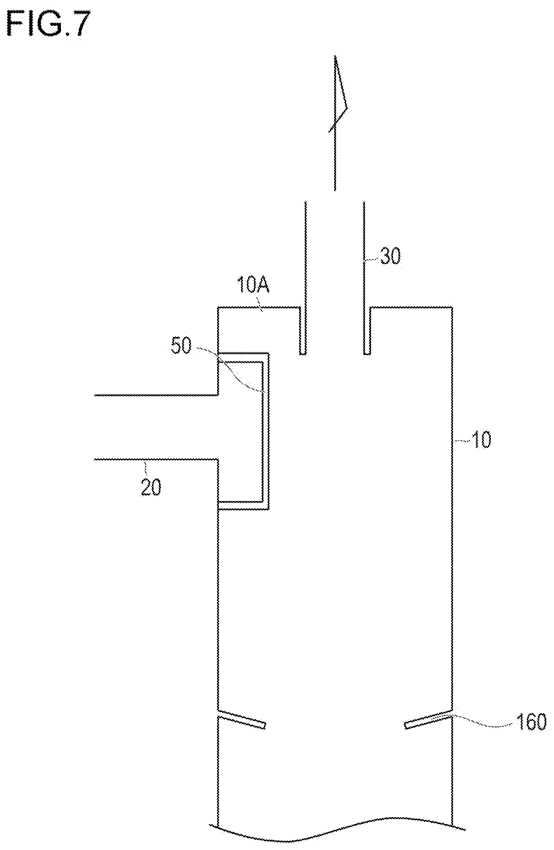

In the above-mentioned embodiment, the partition plate 60 is provided along the horizontal direction. However, as shown in FIG. 7, a partition plate 160 may be configured to be inclined inward in the radial direction and in the downward direction. With such a configuration, it is possible to cause refrigerating machine oil on the partition plate 160 to descend downward along an inclined surface and hence, it is possible to suitably suppress a situation where the refrigerating machine oil is stored on the partition plate 160.

In the above-mentioned embodiment, the straightening plate 50 is formed to have a linear shape when viewed from above. However, the configuration of the straightening plate is not limited to the configuration that has the narrow width portion configured such that the distance between the straightening plate and the inner wall of the body portion gradually decreases toward the end portion from which a gas-liquid mixture flows out. The straightening plate 50 may be formed to have a curved shape, for example.

In the above-mentioned embodiment, the gas-liquid separator 1 includes the partition plate 60 having a toroidal shape. However, it is not always necessary for the gas-liquid separator 1 to include the partition plate having a toroidal shape.

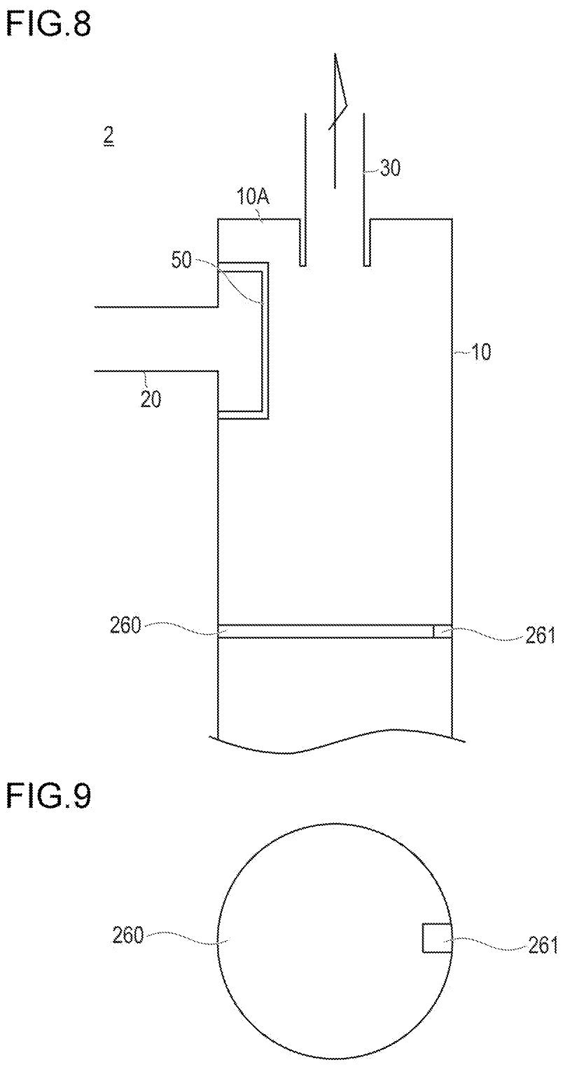

In the above-mentioned embodiment, the gas-liquid separator 1 includes the partition plate 60 having a toroidal shape. However, as shown in FIG. 8 and FIG. 9, a gas-liquid separator 2 may include a partition plate 260 that partitions the body portion 10 into an upper portion and a lower portion in place of the partition plate 60 having a toroidal shape. As shown in FIG. 8 and FIG. 9, the partition plate 260 has a through hole 261 at an end portion, the through hole 261 penetrating through the partition plate 260 in the up-and-down direction. Although a size of the through hole 261 is not particularly limited, when the inner diameter of the body portion 10 is 150 to 160 mm, the size of the through hole 261 is 15 mm×15 mm, for example.

By providing the partition plate 260 having the through hole 261 at the end portion as described above, an amount of the gas-liquid mixture flowing to a space below the partition plate 260 is reduced and hence, it is possible to reduce violent movement of the float valve 90 and movement of an oil surface.

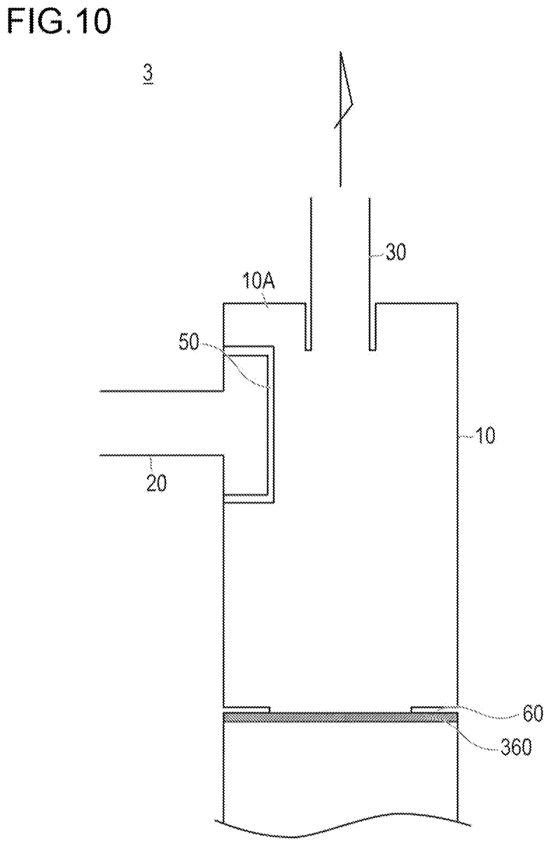

As shown in FIG. 10, in a gas-liquid separator 3, a demister 360 may be attached to the partition plate 60. A method for attaching the demister 360 to the partition plate 60 is not particularly limited. Although the demister 360 is not particularly limited, a demister made of SUS304 and having a wire diameter of 0.12 mm and a density of 360 kg/m3 may be used for the demister 360. In FIG. 10, the demister 360 is attached to a lower side of the partition plate 60. However, the demister 360 may be attached to an upper side of the partition plate 60, or may be attached in a state of being sandwiched between the partition plates 60.

By attaching the demister 360 to the partition plate 60 as described above, the demister 360 can suitably attenuate a swirl flow of a gas-liquid mixture and hence, it is possible to reduce violent movement of the float valve 90 and movement of an oil surface.

Next, performance characteristics of the gas-liquid separator 1 will be described. First, for a gas-liquid mixture being a separation target, in a case where volume concentration of oil in a gas-liquid mixture that flows into the body portion 10 is several percent, a large amount of oil is contained and a swirling force attenuates and hence, it is preferable to use the partition plate 60 shown in FIG. 1 and FIG. 2. In contrast, in a case where volume concentration of oil in a gas-liquid mixture that flows into the body portion 10 is several parts per million, a small amount of oil is contained and a swirling force does not attenuate and hence, a swirl flow generated in the body portion 10 is stronger. Accordingly, it is preferable to suppress violent movement of the float valve 90 and movement of an oil surface by reducing the size of the opening of the partition plate. In a case where it is difficult to determine the size of the opening of the partition plate with respect to volume concentration of oil that flows into the body portion 10, it is preferable to reduce violent movement of the float valve 90 and movement of an oil surface by installing the demister 360 on the partition plate 60 having a large opening to provide a resistance. The above-mentioned advantageous effects can also be obtained even with the configuration of the above-mentioned partition plate 260.

### <EXAMPLE>

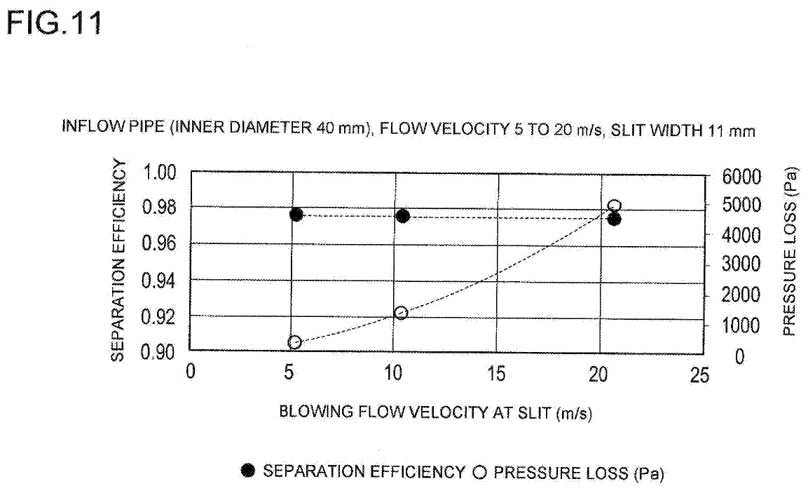

FIG. 11 shows the results obtained by measuring a separation efficiency and a pressure loss when a flow velocity of a gas-liquid mixture introduced into the gas-liquid separator 1 having the above-mentioned configuration through the introduction passage 20 is changed within a range of 5 to 20 m/s.

In FIG. 11, the horizontal axis shows the flow velocity of the gas-liquid mixture, black circles on the vertical axis show the separation efficiency, and white circles on the vertical axis show the pressure loss. As shown in FIG. 11, when the flow velocity of the gas-liquid mixture is changed to 5 m/s, 10 m/s, 15 m/s, and 20 m/s, a separation efficiency of 97% or more can be ensured at every flow velocity. Although the pressure loss increases with an increase in flow velocity of the gas-liquid mixture, it is found that a maximum pressure loss is 5 kPa, which is not an especially high numerical value.

For the characteristic of the gas-liquid separator 1, it is found that a high separation efficiency can be maintained even when a blowing velocity of a swirl flow is changed within a range of 5 m/sec to 20 m/sec. A pressure loss can be changed according to an allowable pressure loss of equipment in which the gas-liquid separator 1 is installed and hence, the degree of freedom in selection is increased.

As described above, in the method for separating refrigerating machine oil in gas with the gas-liquid separator 1 according to this embodiment, first, gas that flows into the body portion 10 through the introduction passage 20 is subject to impingement separation at the straightening plate 50 and, then, a gas-liquid mixture that flows out from the end portion 50A of the straightening plate 50 swirls along the inner wall of the body portion 10, so that gas and liquid are centrifuged. There is no obstacles inhibiting the formation of a swirl flow in a region where swirling starts and hence, it is possible to perform centrifugation and gravitational sedimentation by effectively using the inside of the barrel. Accordingly, it is possible to effectively make use of the space in the barrel and hence, oil is efficiently separated. Further, violent movement of an oil surface of refrigerating machine oil temporarily stored at the lower portion of the body portion 10 and reaccompanying of oil due to the swirl flow are prevented by providing the partition plate 60, 260 at a position above the oil surface and hence, it is possible to recover the separated oil in a stable manner.

Further, it is possible to omit the funnel portion provided at the lower portion and hence, it is possible to achieve a reduction in size and a compact structure. Accordingly, the gas-liquid separator 1 can be used as an oil separator of a gas compressor, can be suitably used for a high-speed multicylinder refrigerating machine, and can be more suitably used for a high-speed multicylinder refrigerating machine for ship having a restriction on a mounting space.

### Reference Signs List

1 gas-liquid separator
10 body portion
10A upper end portion
20 introduction passage
30 exhaust flow passage
40 oil discharge flow passage
50, 150 straightening plate
50A end portion
51 first extending portion
52 second extending portion
53 third extending portion
54 narrow width portion
60, 160, 260 partition plate
90 float valve
360 demister

1. A gas-liquid separator that separates gas and liquid from a gas-liquid mixture, the gas-liquid separator comprising:
a body portion having a cylindrical shape;
an introduction passage provided in a state of communicating with the body portion, the gas-liquid mixture being introduced through the introduction passage;
a straightening plate attached to the body portion to extend in a chord length direction of a circular arc formed by a barrel of the body portion, the straightening plate being configured to straighten the gas-liquid mixture; and
an exhaust flow passage provided for gas from which liquid is separated, wherein the straightening plate has a narrow width portion configured such that a distance between the straightening plate and an inner wall of the body portion gradually decreases toward an end portion from which the gas-liquid mixture flows out, and a swirl portion in the body portion is formed by the body portion extending in an up-and-down direction and a partition plate.

2. The gas-liquid separator according to claim 1, wherein an insertion portion of the exhaust flow passage is inserted into the body portion, and the insertion portion extends by an extension length that allows the insertion portion to reach a position of a height of an upper end of an extending portion of the straightening plate, the extending portion extending in a horizontal direction.

3. The gas-liquid separator according to claim 1, wherein the straightening plate is disposed to extend in the chord length direction of the circular arc formed by the barrel of the body portion when viewed from above, one end of the straightening plate is connected to the inner wall of the body portion, and the other end of the straightening plate has a narrow width portion.

4. The gas-liquid separator according to any claim 1, wherein the straightening plate is attached to extend in the chord length direction of the circular arc having a length corresponding to 1/4 or less of a circumference of the body portion.

5. The gas-liquid separator according to claim 4, wherein the introduction passage is connected at a free angle and with a free offset amount within a range of the circular arc.

6. The gas-liquid separator according to-any claim 1, wherein a fluid is blown out from a distal end portion of the straightening plate, the distal end portion has a narrow width portion, and the narrow width portion is selected such that a blowing velocity of a swirl flow falls within a range of 5 m/sec to 20 m/sec.

7. The gas-liquid separator according to claim 1, wherein the straightening plate has a square U shape when viewed in a front view, and the straightening plate is fixed to the inner wall of the body portion at least at a position higher than the introduction passage.

8. The gas-liquid separator according to claim 1, wherein the partition plate is provided at a position lower than the introduction passage, and has an inner diameter smaller than an inner diameter of the body portion.

9. The gas-liquid separator according to any claim 1, wherein the partition plate is provided along the horizontal direction.

10. The gas-liquid separator according to any claim 1, further comprising a demister attached to the partition plate.

11. The gas-liquid separator according to any claim 1, further comprising the partition plate provided at a position lower than the introduction passage, and configured to partition the body portion into an upper portion and a lower portion, wherein a through hole is formed at an end portion of the partition plate, the through hole penetrating through the partition plate in the up-and-down direction.
